(19) United States
(12) Patent Application Publication
(10) Pub. No.: US 2007/0186277 A1
(43) Pub. Date: Aug. 9, 2007

(54) System and method for utilizing a token for authentication with multiple secure online sites

(76) Inventors: William Loesch, Hillsborough, CA (US); Derek Fluker, Cupertino, CA (US)

Correspondence Address: SHUGHART THOMSON & KILROY, PC, 120 WEST 12TH STREET, KANSAS CITY, MO, 64105, US

(21) Appl. No.: 11/702,741

(22) Filed: Feb. 6, 2007

Related U.S. Application Data
(60) Provisional application No. 60/765,646, filed on Feb. 6, 2006.

(51) Int. Cl. H04L 9/32; G06K 9/00; H04L 9/00; G06F 17/30; H04K 1/00; G06F 15/16; G06F 7/04; G06F 7/58; G06K 19/00

(52) U.S. Cl. 726/4; 726/5; 726/6; 726/7; 713/182

(57) ABSTRACT

A system and method are provided which allow an online user/client to update one or more sign-on address or secure computing devices or tokens or authentication protocols or algorithms employed by multiple, distinct online sites wherein each site may require a different secure computing devices or tokens or authentication protocols or algorithms wherein the secure computing devices or tokens or authentication protocols or algorithms employed by different online services are provided to a central secure server which then distributes the various received secure computing devices or tokens or authentication protocols or algorithms to the identified users of each online service for updating of the user/client's stored secure computing devices or tokens or authentication protocols or algorithms.

### CROSS-REFERENCE TO RELATED APPLICATION

This application claims priority under 35 U.S.C. 119(e) and 37 C.F.R. 1.78(a)(4) based upon copending U.S. Provisional Application, Ser. No. 60/765,646 for SYSTEM AND METHOD FOR UTILIZING ATOKEN FOR AUTHENTICATION WITH MULTIPLE SECURE ONLINE SITES, filed Feb. 6, 2006, which is incorporated herein by reference.

### FIELD OF THE INVENTION

The present invention relates to the field of online computer security. In particular, the present invention provides a system and method for detecting changes in the sign-on requirements of an on-line service, security data changes and security protocol modifications utilized in one or more online authorization or security schemes to one or more users or clients (user/client) of the online services.

The present invention allows user/clients of multiple online services to receive updated versions of log-on or sign-on schemes and/or authorization or security schemes without the need to contact each online service to which the user/client subscribes. The present invention allows updating of multiple user/clients of one or more online services without the need to contact separately each user/client of the online service.

### BACKGROUND OF THE INVENTION

Wide-spread use of the Internet for electronic transactions has resulted in the need for specific and secure identification of a user, or client, (user/client) who wishes to connect with a particular online service or website server so business may be conducted by the user/client, or so the user/client may access confidential information which the user/client may properly obtain. An instance of the most well known form of this type of confidential transaction is the user/client interaction with a savings and loan server or a bank server for transaction of business with the bank or for obtaining information regarding the user/client accounts. Other such instances are user/client interactions with medical providers or insurance companies or government agencies where confidential information related to the user/client is maintained. Also, user/client interactions with Internet businesses, in which repeat electronic commerce transactions are the norm, present situations in which the merchant may wish to employ usernames and passwords to limit site access to recognized user/clients.

Often it will be the case that an operator of an on-line service wishes to modify the design of their website. In such redesigns, the site operator may decide to change the location of the log-on or sign-on page of the on-line service website within the structure of the site. In this event, even with the most simple sign-on or log-on, it will be necessary for the user/client to search within the on-line line service website for the new location of the sign-on or log-on page of the site. This can be an irritating and tedious process particularly if the user/client deals with multiple online services on a frequent basis.

In addition to relocation of the log-on or sign-on page of the on-line service website, a site operator also may employ a background authenticating algorithm to increase security in the process of identification of users of the site. Such a background authenticating algorithm may employ information variables in the algorithm that are supplied by the user/client in the form of their sign-on data or password or username. To increase security of the background authenticating algorithm, the on-line service may modify components or variables within the authenticating algorithm. Such modifications present the need to communicate the modified variable, or an encoded form of the modified variable, to the user/client. It would be most useful if the modification could be separately communicated to the user/client.

By way of illustration, such authentication methods or protocols are available in many forms such as, but not limited to: two-factor authentication, public key cryptography, geolocation, encrypted key exchange (EKE), and secure remote password protocol (SRP).

Two-Factor Authentication (TFA). This is a type of authentication protocol that comprises two independent ways to establish identity and use rights. In contrast, the standard password authentication requires only one ‘factor’—knowing the password—to establish use rights to the system. The use of more than one factor of authentication is known as “strong authentication”, while using just one factor is considered “weak authentication.” Three types of authentication “factors” are typically employed:
“information” such as a password or PIN; and/or
“a device” such as a credit card or hardware token; and/or
“a biometric” such as a fingerprint, a retinal pattern, or the like.

A typical TFA transaction is the use of a bank card, such as a credit card or debit card, in which the card is the “device” and the user also has “information” in the form of a “personal identification number” (PIN).

Secure Remote Password Protocol (SRP). SRP is a password-authenticated key agreement security protocol that allows a user/client to authenticate himself/herself to a server. SRP is resistant to dictionary attacks and does not require use of a trusted third party to operate. A dictionary attack is a technique for defeating a password authentication system by trying to determine the password by attempting a large number of possibilities. A dictionary attack only tries words that present a high probability of use in a language and is based on the fact that most people tend to choose a password that is easy to remember. These easily remembered word usually present a high degree of use in the native language of the user.

SRP conveys a zero-knowledge password proof from the user to the server. Only one password can be guessed at per attempt in Revision 6 of the protocol. The SRP protocol creates a large private key shared between the two parties then verifies to both parties that the two keys are identical and that both sides have the user's password. It should be appreciated that, at anytime, one of the variable values can be changed thus presenting an entirely new security device.

Additional information regarding conventional digital authentication methods and processes can be found in available literature, such as on the Internet, as by doing word searches on: two-factor authentication, public key cryptography, geolocation, encrypted key exchange (EKE), and secure remote password protocol (SRP) on sources such as en.wikipedia.org (www.wikipedia.org for non-English articles) and at www.stanford.edu. Additional information on such authentication methods are available in U.S. Pat. Nos. 4,200,770 and 4,218,582 issued to Hellman et al., which are incorporated herein by reference.

Referring to FIG. 1 showing a conventional system 200 of user/clients 202 and service provider servers 204, a plurality of user/clients 202 have accounts with selected ones of a plurality of service provider servers 204. It should be appreciated that each time a change in a security device was desired by an online service or server 204, the change in that security device was required to be communicated to each user/client 202 of the online service. For example in FIG. 1, Server 1 must communicate the new security device or sign-on protocol to each of user/client 1 and user/client 2 and user/client 4. This same communication requirement applies to every other online server 204,—Server 2, Server 3, and on to Server . . . N.

### SUMMARY OF THE INVENTION

By use of the present invention, such modifications in the location of the log-on or sign-on page of the on-line service or modifications to authentication methods or protocols or other security devices can be made at will by an online service and communicated to the user/client of the on-line service by use of the present invention. In this manner, the user/client can become aware of modifications in the location of the log-on or sign-on page of the on-line service or changes in the security device without the user/client having use of the online service interrupted.

In addition, where the user/client employs a portable secure computing device such as a token or smart card or an information-containing device such as a magnetic stripe (magstripe) card, these devices can be more effectively employed and updates made through use of the present invention. Such tokens, smart cards, dongles, or similar security devices are typically combined with an additional bit of user information such as a personal identification number (PIN) which the user enters into the computer system to corroborate that the physical token device, smart card, or magstripe card is actually being used by the correct individual. When these tokens, smart cards, dongles, or similar security devices are used in conjunction with the present invention, the data contained on the token or smart card or magstripe card or dongle can be updated by the present invention; and more complicated user names and passwords can be selected by the user/client. The present invention can, if desired, add the modified sign-on page location or modifications to authentication methods or protocols or other security devices to the data stored on the token or smart card or magstripe card or dongle.

A system and method are provided by the present invention which allow an online user/client to update a computer database or update a security device or token or smart card with updated on-line service sign-on page addresses and/or modified on-line service authentication protocols or algorithms and which are employed by multiple, distinct online sites. Under the present invention, each site may require a different information from the security devices or tokens or different authentication protocols or algorithms.

More particularly, the updated sign-on location or authentication protocol information generated by the on-line services is sent to, or detected by, a central secure depository server which then distributes the update information to user/client computer databases and/or user/client security devices or tokens or smart cards or dongles by a variety of methods including, but not limited to, the depository server contacting each user/client or the depository server being contacted by the user/client on a scheduled basis.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations.

Objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

Preferred embodiments of the invention, illustrative of the best modes in which the applicant has contemplated applying the principles, are set forth in the following description and are shown in the drawings and are particularly and distinctly pointed out and set forth in the appended claims.

### BRIEF DESCRIPTION OF THE DRAWINGS

FIG. 1 is a block diagram and illustrates a system of service provider servers and user/client computers employing a prior art method of communication between the servers and the user/clients where each server and each client/user of the online service must individually communicate for the exchange of sign-on protocols, security protocols, updates, data modifications, and the like.

FIG. 2 is a block diagram illustrating a system of service provider servers, user/client computers, and a depository server to store and provide access to sign-on protocols of the service provider servers to the user/client computers, according to the present invention.

FIG. 3 is a block diagram illustrating components of a user computer system it relation to a plurality of online servers and a depository server, all communicating over the Internet.

FIG. 4 is a flow diagram illustrating principal steps in a process for updating sign-on protocols or security data using user tokens and a depository server, according to the present invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

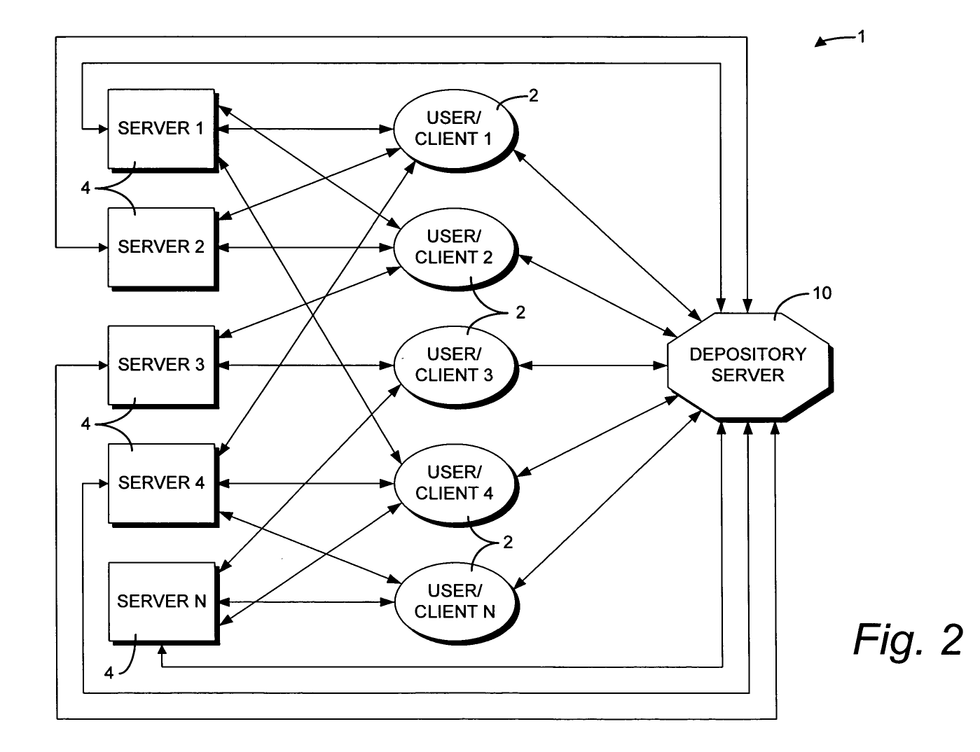

Referring to the drawings in more detail, the reference numeral 1 (FIG. 2) generally designates a system of online service provider servers 4 with which access is desired or needed by a plurality of user/client computers 2. The online servers 4 may, for example, be financial institutions, commercial vendors, governmental entities, software providers, business servers, or the like. As is illustrated in FIG. 2, the relationships among the servers 4 and the client computers 2 is a complex one. In particular, each client 2 may have multiple accounts with some of the servers 4 and require access thereto. Not all clients 2 have accounts with all the servers 4. For example, user/client No. 1 has accounts with servers Nos. 1, 2, and 3. In a similar manner, user/client No. 3 has accounts with server No. 3 and server No. N. As illustrated in FIG. 2, each of the servers 4 and each of the client computers 2 also has access to a special server, designated a depository server 10, as will be detailed below.

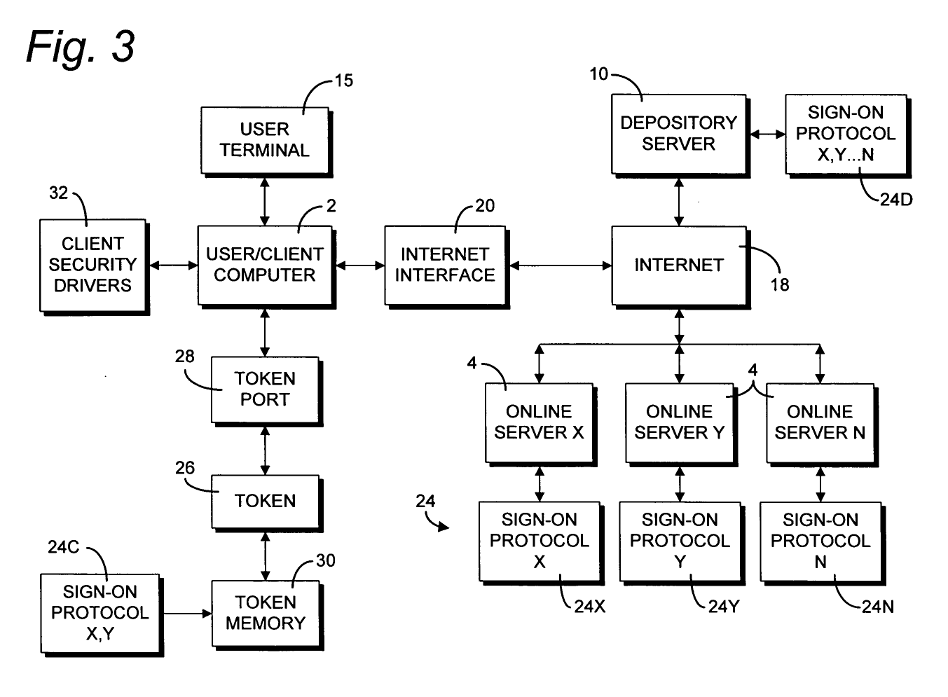

Referring to FIG. 3, each user/client computer 2 includes a user terminal 15, such as a display, keyboard, and mouse (not shown), by which the user accesses the computer 2. Access among the user/client computers 2, servers 4, and depository server 10 takes place over the Internet 18 or other universal computer network. Thus, the client computer 2 has an internet interface, including necessary port hardware and software, such as a browser. As described above, each online server 4 has its own sign-on and authentication protocols 24 for access to the services thereof, which may involve accessing a particular web page, the exchange of security data, particular algorithms for processing the exchanged security data, and the like. The security data exchanges, sign-on or log-on requirements, and the like are referred to herein as sign-on protocols 24. In order for a client 2 to access a particular server 4, such as server X, it is necessary that the client 2 have a stored copy of the client portion of the sign-on protocol 24C (24-Client) for server X. Each client 2 may require access to multiple servers 4. Therefore, multiple sign-on protocols 24 may be stored on a given client computer 2.

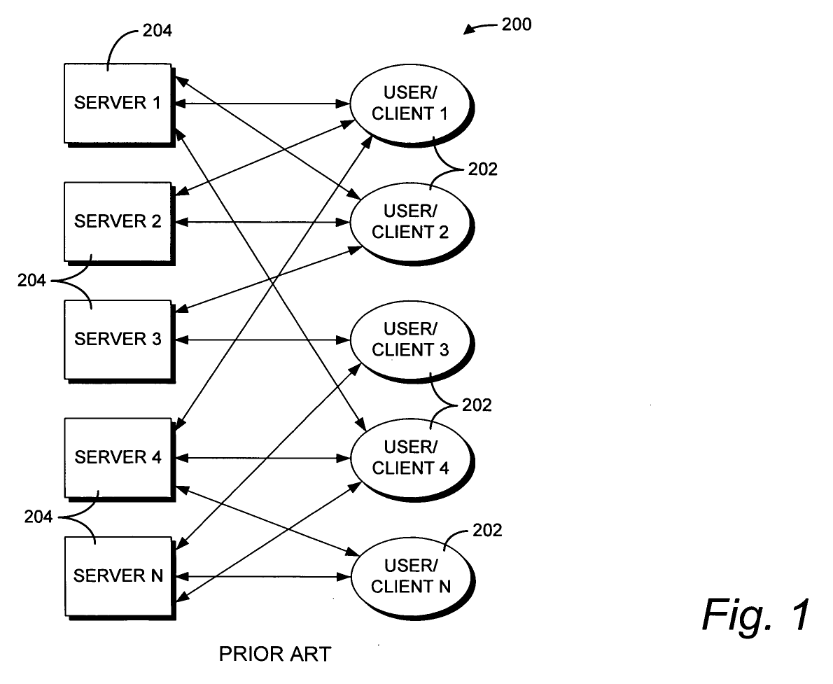

For various reasons, such as enhanced security, operational efficiency, or the like, the servers 4 may update their sign-on protocols 24. Under the arrangement 200 shown in FIG. 1, it would be necessary for a server 4 updating its sign-on protocols 24 to contact each user/client 2 having an account therewith to update their local sign-on protocol 24C, such as on the next attempted access by a particular user/client 2 to the server 4 which made the change. The need for each client computer 2 to download the updated sign-on protocol 24 can congest the communication “bandwidth” of the server 4 requiring the update during times of high traffic.

To overcome problems associated with conventional arrangements for updating sign-on protocols 24, the present invention provides the depository server 10 which functions to store updated sign-on protocols 24D (24-Depository) for each of the servers 4. The depository server 10 may then be contacted by each of the user/client computers 2 to obtain the latest updated sign-on protocols 24 for the particular servers 4 with which they have accounts. The depository server 10 may be owned by the owner of one of the online service servers 4, by a consortium of such servers, or may be owned and operated by an independent entity which contracts its depository services to the online servers 4. The procedures for contact between the depository server 10 and the clients 2 may occur in a number of different ways, as will be described below.

Although client sign-on protocols 24C can be stored on a hard drive (not shown) of the client computer 2, the present invention recognizes the enhanced security of a “security token” 26, such as a dongle, smart card, magstripe card, or the like, which will be referred to generically herein as a token 26. The token 26 is interfaced to the client computer 2 by way of a token port 28, which may be a standard type of interface such as a universal serial bus (USB) interface, an IEEE 1394 (Firewire) interface, an RS-232 serial port, or the like. The token port 28 could conceivably include a reader device, such as for a smart card or magstripe card, which may be interfaced to a standard type of port on the client computer 2. The token 26 includes token memory 30 which typically includes some read-only memory (ROM) and rewritable memory (RAM) which is preferably a non-volatile memory such as Flash RAM. The read-only memory may include hard programmed data, such as a serial number, and firmware, such as program for processing portions of the sign-on protocol 24C. The Flash RAM is used to store the current sign-on protocols 24C and, possibly, a user password or personal identification number (P.I.N.). The client computer 2 may require client security drivers 32, which may be provided by the online servers 4 or by the depository server 10 for accessing the sign-on protocols 24C stored in the token 26.

Practicing the present invention 1 presents at least three options for use. First is the option in which the depository server 10 contacts user/clients 2 to provide the user/client with an update of information stored on the user/client computer 2 to allow correct sign-on and authentication protocols for those on-line services used by the user/client.

In a second option of the present invention, each user/client performs, usually in a prescheduled manner, a general request to the depository server 10 to receive all updated sign-on protocols 24D related to all online servers 4 contained in the depository server and which updated sign-on protocols are then transmitted to the user/client computers 2 by the depository server 10. Typically, this would be a regularly scheduled operation by the user/client computer 2 of the type which is currently applied to obtaining updates for many types of software.

In a third option the user/client contacts the depository server 10 on each use of the online server 4. In particular, the user/client computer 2 would query the depository server database with respect to specific online service to determine if any changes in the access to the online service had been made.

In operation of the present invention, a database is prepared on the depository server 10 which contains relevant data necessary to achieve access to multiple online services. For example, the depository server 10 would contain information regarding online server X indicating the specific address for the sign-on page of the online service X. It will be appreciated by those skilled in the art that a sign-on page for any particular online service may be a quite different page from the initial opening page or home page of the website and that after reaching the opening page of the website additional navigation through the website may be required to display the sign-on page of the site. In the present invention, the depository server 10 actively investigates online service websites for sign-on functionalities to determine the exact address of the sign-on page. Such predetermination of the sign-on functionalities allows a user having access to the depository server database and the software and drivers of the present invention to be immediately directed to the sign-on page of the online service where additional information required by the sign-on page may be supplied through the token 26 of the present invention or supplied by the user/client manually.

It will be appreciated that the depository server 10, in addition to actively seeking out the precise address of the sign-on or login page for an online service, also will determine other features of the sign-on page which are necessary to successfully achieving access to the online service. For example, a particular sign-on page of an online service 4 may require that a user name be entered as well as a password and in some cases an identifying PIN or social security number be entered to achieve access to the online service. In addition to such particular pieces of information, the active investigation by the depository server may determine that supplying the information to fulfill each one of these sign-on page information queries cannot be accomplished by a paste function, but rather, must be detected by the online service sign-on page through actual keystrokes generated by the user/client computer 2. These types of differences, and others, in on-line sites are determined in the present invention by the active investigation conducted by the depository server 10 and these features, and the modifications to these features, of the on-line sites 4 are then stored in the depository server database for any particular online service.

It will be appreciated that the active probing of an online service website by the depository server 10 is not in any form an attack on the website; rather it is simply a matter of obtaining information regarding the structure and functionality of the website that will be useful to any legitimate user/client of the online service website. It will further be appreciated to those skilled in the art that the present invention provides the benefit of convenience to an online user in that the information on any number of online websites is maintained on the depository server 10 and the information necessary to properly direct and identify the user/client to the online web service server 4 is provided through the use of the present invention and stored on the user/client computer 2 or token 26 and subsequently automatically supplied from the user/client computer 2 or token 26 as the user/client signs-on to the online service website 4. More importantly, through use of the present invention, additional security is provided to the user/client in the form of permitting the user/client to establish substantially longer and more complicated and nearly random character strings for use as the user name and password and/or as any other user/client selected sign-on information required by an online service or website. This aspect of the present invention is provided through the use of the mechanical security device or token 26 which is employed by the user/client as part of the present invention.

In the present invention, the user/client uses the token 26 such as a smart card type device which may be in the form of a USB (universal serial bus) connectable device such as a dongle provided with a USB connection. The smart card or USB dongle is provided with a non-volatile memory on which the user can store multiple passwords and multiple user names associated with those passwords as well as the social security number of the user and/or any other information required for sign-on to any number of websites. It will be appreciated that access to the token 26 is limited by the need to enter a personal identification number (PIN) to achieve access to the token. In this manner, by use of the token 26, the user is able to generate, but not have to remember, a different user ID and different user password for each online service utilized by the user/client. It also will be appreciated that because the user is no longer required to retain the user name or password or other information necessary for sign-on within the user's own human memory or for the user to actually type in this security data, the user may now select much longer character strings for use as user names and user IDs as well as essentially random characters in a string for use as user names and user IDs, thus heightening the level of security attached to the user names and passwords selected by the user. It also will be appreciated on a practical circumstance that as the user no longer needs to actually type in by hand the user name and password that the danger of mis-entry or “fat fingering” entry of a user name or user password is avoid, thereby facilitating the use of longer and more random character strings as user names and passwords.

In operation of the present invention it will be appreciated that a user/client subscribes or establishes an account or relationship with the depository server 10. The user loads the software and relevant security drivers 32 needed to operate the present invention onto the user/client computer 2. The software and drivers 32 installed onto the user's machine 2 permit the automatic addressing or polling of the depository server 10 to occur for obtaining sign-on protocol updates. The software also permits proper interaction between this sign-on protocol 24 obtained from the depository server 10 and the user/client token 26. When the user has downloaded and installed the software of the present invention onto the user/client's computer, and once the user has access to the depository server 10 to update the sign-on protocol 24C which is resident on the user/client's computer 2 from the database which is stored on the depository server 10, the user/client is now prepared to operate the present invention.

The operation of the present invention is effected generally by the user selecting an online service to access from a list that is presented to the user/client whereupon the user will simply select the online service to be accessed, and the software of the present invention will begin functioning to contact the online service and to achieve sign-on and authorization for use of the online service on behalf of the user/client. This functionality proceeds by the software recognizing the identity of the online service and referring to the updatable sign-on protocol 24C on the user/client machine to determine the proper address to be used for direct sign-on to the on-line service or website. The software also determines from the updatable database the necessary information or parameters required for successfully completing the sign-on requirements of the online service. The software then will seek the appropriate data for entry into the sign-on page of the website from the token 26 which has been physically connected to the user/client computer 2 through use of the token port 28. The software will request that the user/client enter a P.I.N. number or other identification parameter or string into the computer to demonstrate that the current user of the computer 2 and individual in possession of the token 26 in fact has permission to access the sign-on protocol 24C. Once the software recognizes that the proper authentication has been entered into the computer 2, the software will obtain from the data recorded on the token 26 the appropriate sign-on protocol 24C needed for entry into the sign-on page of the selected online user website and transmit that information in appropriate fashion to the sign-on page of the online server 4, thus effecting connection and authorization for the user/client to utilize the online service.

It will be appreciated by those skilled in the art that the above operation adds further security to the user/client's use of online services. Preferably, the need to make actual keystrokes for entry of data onto the sign-on or login page of the online service is avoided thereby frustrating the use of spyware and other keystroke recording devices or keystroke transmitting software employed by third parties to obtain security information from unwary computer users.

In an alternative embodiment of the present invention, it is possible for a distinction to be made between secure online financial service websites and secure non-financial secure favorite websites. In the case of the non-financial secure websites, it may be convenient to have the URL or sign-on page address of the website stored on the token 26 to further speed access to the online service. In the case of secure financial sites, the URL or sign-on page address is not stored on the token 26; rather the URL or sign-on page address is supplied from the depository server 10 which validated and authenticated the URL or sign-on page address and updated on the user's resident machine database.

In another alternate embodiment of the present invention, updates and/or modifications to the authentication protocols or algorithms of an online site are tracked by the depository server 10. An online service is able to select and use any protocol or algorithm it chooses and to modify or change the protocol or algorithm at will without degrading or interrupting the service experience by the authorized user/client.

For purposes of the present invention the term security device is understood to include any form of protocol 24 or algorithm or authorization data by which a user/client of an online service receives permission to use or gain access to the online service. Such security devices are understood to include passwords, server protocols or algorithms by which user transmitted information (such as a personal identification number (P.I.N.) or password or data contained on a smart card or other token 26) is processed by the on-line service to authenticate the user/client. Hereinafter these forms of security devices and others which are not specifically named herein but which would be known to those skilled in the art shall be referred to collectively as “security device(s)” or sign-on protocols 24.

In the present invention a security device 24 that is currently used by an online service or a security device 24 that is to be modified or replaced by the online service is communicated to a separate server which is referred to herein as the “depository server” 10. The depository server 10 then acts as a central repository and updating server which can communicate security device modifications or new security devices 24 to the user/clients 2 of the various online services 4 that have been polled by the depository server 10. Typically, in a preferred embodiment, the depository server 10 will identify financial services and online websites and poll those sites to obtain the sign-on or authentication or other desired data. In an alternative embodiment, the relationship between the on-line services 4 and the depository server 10 may be a subscription type of service in which the online services 4 pay for the services provided by the depository server 10.

In this manner, the online service 4 is relieved of the need to communicate changes in its security device 24 to each of its clients 2 individually at the time the user/client next chooses to contact the online service. Instead the depository server 10 communicates with the user/client to update the user/client's security device 24 or to update multiple security devices 24 used by the user/client 2 to contact a variety of online services 4. The present invention provides several advantages to both online services 4 and to user/clients 2: (1) the online service 4 does not itself have to provide the updating of the security device 24; (2) if there are problems with the actual communication of the security device 24, the depository server 10 can respond to the user/client problems or inquiries outside of the regular business of the online service 4; (3) if the user/client computer equipment 2 is lost or damaged, the user/client is provided with a central service or central mechanism for re-establishing all previously existing security devices 24 without having to individually contact each online service 4 with which the user/client 2 has interacted; (4) the secure communication between the depository server 10 and the client/user 2 presents an additional layer of security for the online service 4 and the user/client 2 , in contrast to the user/client obtaining the modified security device 24 directly from the online service; and (5) the online service 4 can more frequently modify its security device(s) 24 thereby increasing the security of its system.

It will be appreciated that only a portion of the overall security device 24 may need be communicated to the depository server 10—that portion subject to modification—and therefore the online service 4 is not exposing its entire security device 24 to any outside entity, such that the internal portions of the online service's security device 24 remain confidential to the online service 4.

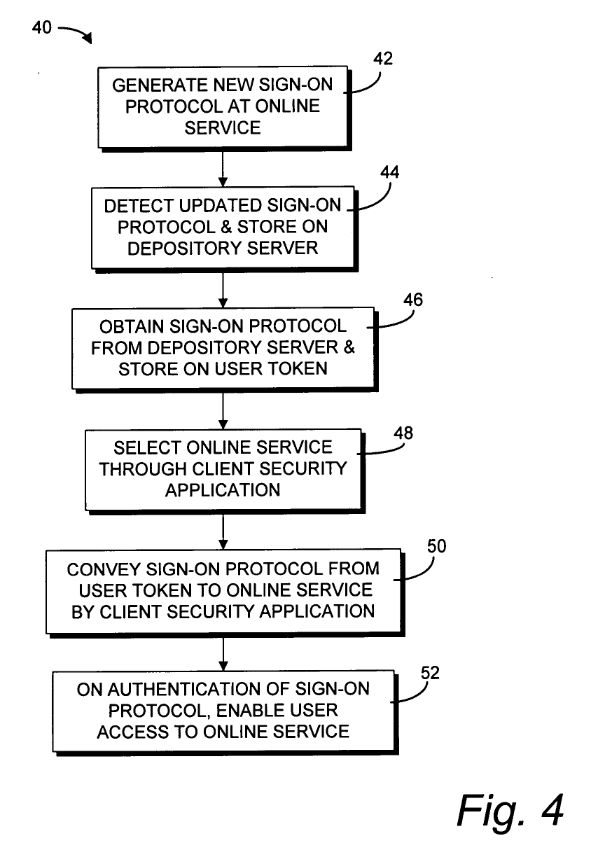

FIG. 4 diagrammatically illustrates a general process 40 for practicing the present invention. At step 42, an online server 4 generates a new sign-on protocol 24. The updated sign-on protocol 24 is communicated to the depository server 10 at step 44, by contact of the depository server 10 by the server 4 or by periodic querying of the servers 4 by the depository server 10. The updated sign-on protocol 24 is communicated from the depository server 10 to a user/client computer 2 at step 46, using one of the three options described above; namely by the depository server 10 contacting user/client computers 2 having accounts with the server 4 which updated its sign-on protocol 24, by the user 2 accessing the depository server 10 in a prescheduled manner to request any updated sign-on protocols 24, or by the user computer 2 contacting the depository server 10 at the time of attempted access to an associated server 4, by use of the client security drivers 32. At step 48, the user selects an online server 4 by use of the client security application or drivers 32. The sign-on protocol 24 for the selected server 4 is conveyed from the user token 26 to the server 4 at step 50 by the client security application 32 along with any other access data, such as user name, password, PIN or the like. Upon authentication of the sign-on protocol 24 by the server 4 at step 52, the server 4 enables access to its services to the user/client computer 2.

It will be appreciated by those skilled in the art that upon receipt of a new security device or sign-on protocol 24, the mechanics of using the definition are carried out by the user/client software 32. All the user must do to access a particular server 4 is to select its name from a list of servers 4 stored on the depository server 10. Seamless access to the online service 4 then occurs for the user because all of the information and mechanics needed to access a site is handled by the client software 32.

It further will be appreciated that new online service accounts may be configured by the user in the user/client software interface by selecting the desired online service server 4 from a list provided by the depository server 10. The depository server database can supply the user/client software 32 with data indicating what security device 24 (information or credentials, specific to a server 4) is needed for its access. The type and variety of information needed may vary from server to server. This information is then gathered securely by the client software 32 only once and stored for future server access by the client software.

Unlike other security or authentication methods no prior, coordinated, or additional configuration of the online service server security device 24 and user/client security device 24C is needed to securely access a server 4. The configurations requirements are dynamically obtained from the depository server 10 and are independent of which user/client is trying to establish access to a particular online service server 4. The understanding and use of existing online service server access methods by the user/client software 32 removes the requirement imposed by existing token access methods for new server enrollment software support on each server.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive system and method for online security devices are constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

While the systems and processes of the present invention have been described and illustrated with particular reference to security and sign-on protocols 24, it is foreseen that aspects of the present invention could also be employed with other types of updates, such as with updated versions of software, updated virus signatures, updated spyware protections, and the like.

Therefore, it is to be understood that while certain forms of the present invention have been illustrated and described herein, it is not to be limited to the specific forms or arrangement of parts described and shown.

What is claimed and desired to be secured by Letters Patent is:

1. A process for updating a plurality of digital sign-on protocols of a respective plurality of online servers for access by client computers to selected ones of said online servers and comprising the steps of:
(a) obtaining each sign-on protocol from a respective online server by a depository server and storing each sign-on protocol in a sign-on protocol database of said depository server; and
(b) communicating each sign-on protocol from said depository server to at least each client computer having an account with the online server associated with the respective sign-on protocol.

2. A process as set forth in claim 1 and including the step of:
(a) obtaining at least some of said sign-on protocols from selected ones of said online servers by said selected ones of said online servers communicating associated sign-on protocols thereof to said depository server.

3. A process as set forth in claim 1 and including the step of:
(a) communicating every sign-on protocol from said depository server to every client computer having an account with said depository server.

4. A process as set forth in claim 1 and including the step of:
(a) storing said sign-on protocols communicated to at least one of said client computers on a token device removably interfaced to said one of said client computers.

5. A process as set forth in claim 1 and including the steps of:
(a) detecting an updated sign-on protocol deployed by at least one of said online servers by said depository server;
(b) storing said updated sign-on protocol in said sign-on protocol database of said depository server; and
(c) communicating said updated sign-on protocol from said depository server at least to said client computers having accounts with the online server associated with said updated sign-on protocol.

6. A process as set forth in claim 5 and including the steps of:
(a) said depository server maintaining said sign-on protocol database storing respective current sign-on protocols for each of said plurality of online servers; and
(b) said depository server periodically communicating an updated sign-on protocol file including said respective current sign-on protocols for each of said plurality of online servers to each client computer having an account with said depository server.

7. A process as set forth in claim 5 and including the steps of:
(a) said depository server contacting each client computer having an account with an online server associated with a particular updated sign-on protocol and conveying said updated sign-on protocol to said client computer; and
(b) each client computer receiving said updated sign-on protocol storing said updated sign-on protocol for use in accessing the online server associated with said updated sign-on protocol.

8. A process as set forth in claim 5 and including the steps of:
(a) each client computer periodically querying said depository server for any updated sign-on protocol of any online server with which the querying client computer has an account; and
(b) said depository server communicating any available updated sign-on protocol requested by said querying client computer to said querying client computer.

9. A process as set forth in claim 5 and including the steps of:
(a) each client computer, upon attempting to access an online server, querying said depository server for any updated sign-on protocol of the online server which said client computer is attempting to access; and
(b) said depository server communicating any available updated sign-on protocol requested by said querying client computer to said querying client computer.

10. A process for updating a plurality of digital sign-on protocols of a respective plurality of online servers for access by client computers to selected ones of said online servers and comprising the steps of:
(a) obtaining each sign-on protocol from a respective online server by a depository server and storing each sign-on protocol in a sign-on protocol database of said depository server;
(b) communicating each sign-on protocol from said depository server to at least each client computer having an account with the online server associated with the respective sign-on protocol;
(c) detecting an updated sign-on protocol deployed by at least one of said online servers by said depository server;
(d) storing said updated sign-on protocol in said sign-on protocol database of said depository server; and
(e) communicating said updated sign-on protocol from said depository server to at least said client computers having accounts with said associated online server.

11. A process as set forth in claim 10 and including the step of:
(a) obtaining at least some of said sign-on protocols from selected ones of said online servers by said selected ones of said online servers communicating associated sign-on protocols thereof to said depository server.

12. A process as set forth in claim 10 and including the step of:
(a) communicating every sign-on protocol from said depository server to every client computer having an account with said depository server.

13. A process as set forth in claim 10 and including the step of:
(a) storing said sign-on protocols communicated to at least one of said client computers on a token device removably interfaced to said one of said client computers.

14. A process as set forth in claim 10 and including the steps of:
(a) said depository server maintaining said sign-on protocol database by storing respective current sign-on protocols for each of said plurality of online servers therein; and
(b) said depository server periodically communicating an updated sign-on protocol file including said respective current sign-on protocols for each of said plurality of online servers to each client computer having an account with said depository server.

15. A process as set forth in claim 10 and including the steps of:
(a) said depository server contacting each client computer having an account with an online server associated with a particular updated sign-on protocol and conveying said updated sign-on protocol to said client computer; and
(b) each client computer receiving said updated sign-on protocol storing said updated sign-on protocol for use in accessing the online server associated with said updated sign-on protocol.

16. A process as set forth in claim 10 and including the steps of:
(a) each client computer periodically querying said depository server for any updated sign-on protocol of any online server with which the querying client computer has an account; and
(b) said depository server communicating any available updated sign-on protocol requested by said querying client computer to said querying client computer.

17. A process as set forth in claim 10 and including the steps of:
(a) each client computer, upon attempting to access an online server, querying said depository server for any updated sign-on protocol of the online server which said client computer is attempting to access; and
(b) said depository server communicating any available updated sign-on protocol requested by said querying client computer to said querying client computer.

18. A process for updating a plurality of digital sign-on protocols of a respective plurality of online servers for access by client computers to selected ones of said online servers and comprising the steps of:
(a) obtaining each sign-on protocol from a respective online server by a depository server and storing each sign-on protocol in a sign-on protocol database of said depository server;
(b) communicating each sign-on protocol from said depository server to each client computer having an account with said depository server;
(c) detecting an updated sign-on protocol deployed by at least one of said online servers by said depository server;
(d) storing said updated sign-on protocol in said sign-on protocol database of said depository server;
(e) communicating said updated sign-on protocol from said depository server each of said client computers having an account with said depository server; and
(f) storing said sign-on protocols communicated to at least one of said client computers on a token device removably interfaced to said one of said client computers.

19. A process as set forth in claim 18 and including the step of:
(a) obtaining at least some of said sign-on protocols from selected ones of said online servers by said selected ones of said online servers communicating associated sign-on protocols thereof to said depository server.

20. A process as set forth in claim 18 and including the steps of:
(a) said depository server maintaining said sign-on protocol database by storing respective current sign-on protocols for each of said plurality of online servers therein; and
(b) said depository server periodically communicating an updated sign-on protocol file including said respective current sign-on protocols for each of said plurality of online servers to each client computer having an account with said depository server.
